(19) United States
(12) Patent Application Publication
(10) Pub. No.: US 2009/0079714 A1
(43) Pub. Date: Mar. 26, 2009

(54) APPARATUS FOR IMPROVING DISPLAY QUALITY OF DYNAMIC IMAGES ON LIQUID CRYSTAL DISPLAY AND METHOD THEREOF

(75) Inventors: Cheng-Chung Shih, Taipei County (TW); Liang-Kuei Hsu, Hsinchu County (TW); Tsun-Tu Wang, Hsinchu County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: NOVATEK MICROELECTRONICS CORP., Hsinchu (TW)

(21) Appl. No.: 12/018,161

(22) Filed: Jan. 22, 2008

(30) Foreign Application Priority Data
Sep. 21, 2007 (TW) 96135386

(51) Int. Cl. G09G 5/00

(52) U.S. Cl. 345/204

(57) ABSTRACT

An apparatus for improving display quality of dynamic image on liquid crystal display (LCD) and a method thereof are provided. The apparatus includes an image data processing unit and an overdrive correcting unit. The overdrive correcting unit is coupled to the image data processing unit. The image data processing unit receives the image data and performs image processing. Then the image data processing unit stores the image data of previous frame after image processing. The overdrive correcting unit receives the image data of previous frame and current frame from the image data processing unit, and generates overdrive image data corresponding to the image data according to the image data of the previous frame and the image data of the current frame.

### CROSS-REFERENCE TO RELATED APPLICATION

This application claims the priority benefit of Taiwan application serial no. 96135386, filed on Sep. 21, 2007. The entirety of the above-mentioned patent application is hereby incorporated by reference herein and made a part of this specification.

### BACKGROUND OF THE INVENTION

1. Field of the Invention

The present invention relates to an apparatus for improving display quality of dynamic image on a liquid crystal display (LCD) and a method thereof. More particularly, the present invention relates to an apparatus for improving display quality of dynamic images on an LCD having an image processing mechanism and a method thereof, capable of flexibly adjusting memory capacity and image processing method.

2. Description of Related Art

Liquid crystal display (LCD) has advantages such as small size and low power consumption, so it increasingly replaces conventional cathode ray tube screen. No matter for small mobile phone screen or large-scale advertisement board, LCD is used in the screen. However, for dynamic images, twisting speed of liquid crystal units in the LCD is too slow. Therefore, ghost and ambiguity phenomenon may be generated in frames of the LCD, thereby causing poor quality of the dynamic images.

Recently, for the dynamic images, a control circuit of the LCD performs an overdrive action on each liquid crystal unit intending to change the state, so as to improve the twisting speed of the liquid crystal units. Therefore, the quality of the dynamic image can be improved without the generation of the ghost phenomenon.

FIG. 1 is a circuit diagram of a conventional apparatus for improving display quality of dynamic images on an LCD. The circuit includes a frame memory 10 and an overdrive look-up table 11. The overdrive look-up table 11 is coupled to the frame memory 10. As shown in FIG. 1, the frame memory 10 records image data of a previous frame, and outputs the image data of the previous frame to the overdrive look-up table 11. The overdrive look-up table 11 is a two-dimensional table receiving the image data of the previous frame from the frame memory 10 and image data of a current frame Data_IN. By using the image data of the previous frame from the frame memory 10 and the image data of the current frame Data_IN as indexes, the overdrive look-up table 11 generates overdrive image data corresponding to those image data. The value of the overdrive image data is an overdrive value capable of increasing twisting speed of the liquid crystal unit. A source driver 12 receives the overdrive image data, and generates a corresponding analog driving signal according to the overdrive image data, so as to drive a display panel. Therefore, the display quality of the dynamic images on LCD can be improved, and the ghost phenomenon will not occur.

For the circuit of the conventional apparatus for improving the display quality of the dynamic images on LCD, although the architecture is simple, it is still necessary for the frame memory to store the image data of a whole frame. Therefore, the circuit needs a larger memory area, and the memory area usually increases the area of the chip, increases the manufacture cost of the chip, which does not satisfy the recent trend of the electronic product.

Accordingly, the present invention provides an apparatus for improving display quality of dynamic images on LCD and a method therefore, so as to overcome the problems.

### SUMMARY OF THE INVENTION

Accordingly, the present invention is directed to provide an apparatus for improving display quality of dynamic images on an LCD. More particularly, the present invention is directed to provide an apparatus for improving display quality of dynamic images on an LCD using an image processing mechanism to make the area of the memory required for storing the image data of the frame smaller than the area of the memory required in the conventional art, and a method thereof. The apparatus and the method can flexibly adjust the memory capacity and the image processing method.

The present invention provides an apparatus for improving display quality of dynamic images on an LCD. The apparatus includes an image data processing unit and an overdrive correcting unit coupled with each other. The image data processing unit receives a successive image data, performs an image processing on each image, and stores image data of a previous frame after the processing. The overdrive correcting unit receives the image data of the previous frame sent from the image data processing unit and image data of a current frame, and generates overdrive image data corresponding to the current image data according to the image data of the previous frame and the image data of the current frame.

The present invention provides a method of improving display quality of dynamic images on an LCD. The method includes receiving a successive frame image data, performing an image processing on the image data, and storing the image data of the previous frame after the processing. Then, the image data of the previous frame sent from the image data processing unit and the image data of the current frame are received, and overdrive image data corresponding to the current image data is generated according to the image data of the previous frame and the image data of the current frame.

In the apparatus for improving display quality of dynamic images on an LCD and the method thereof according to an embodiment of the present invention, the image data processing unit includes a first image data processor and a register memory coupled with each other. The first image data processor performs the image processing on the input image data. The register memory records the image data of the previous frame after the image processing performed by the first image data processor. The memory capacity required by the register memory is smaller than the memory capacity required by storing a whole frame.

In the apparatus for improving the display quality of the liquid crystal dynamic image and the method thereof according to the embodiment of the present invention, the apparatus for improving display quality of dynamic images on an LCD further includes a frame memory for storing the image data of the current frame.

In the apparatus for improving display quality of dynamic images on an LCD and the method thereof according to the embodiment of the present invention, the image processing includes quantization, scaling, compression, decompression, transform, inverse transform or combinations thereof.

In the apparatus for improving display quality of dynamic images on an LCD and the method thereof according to the embodiment of the present invention, the overdrive correcting unit includes a compensation value generating unit and an adder. The compensation value generating unit receives the image data of the previous frame output by the image processing unit and the image data of the current frame, and generates corresponding compensation values. The adder performs addition on the value of the image data of the current frame and the compensation value, so as to generate the overdrive image data. The compensation value generating unit includes a look-up table for outputting the compensation values corresponding to the current input image data. The look-up table only records a part of the compensation values corresponding to the input image data, and generates unrecorded compensation values corresponding to the current input image data by means of interpolation according to the recorded compensation values.

To sum up, the apparatus for improving display quality of dynamic images on an LCD and the method thereof of the present invention adopts an image processing unit to firstly perform the image processing on the image data. Then, the image data of the previous frame after the processing performed by the image processing unit is stored. Number of bits of the image data of the previous frame after the image processing is smaller than number of bits of the image data of a whole frame, so it is unnecessary to use a frame memory to wholly store the image data of a whole frame. Therefore, the memory capacity required by the apparatus for improving display quality of dynamic images on LCD is reduced, thereby reducing the chip area and the manufacture cost. It can be known from a part of the embodiments that the apparatus for improving display quality of dynamic images on LCD and the method thereof provided by the present invention can flexibly adjust the memory capacity and the image processing method.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional apparatus for improving display quality of dynamic images on LCD.

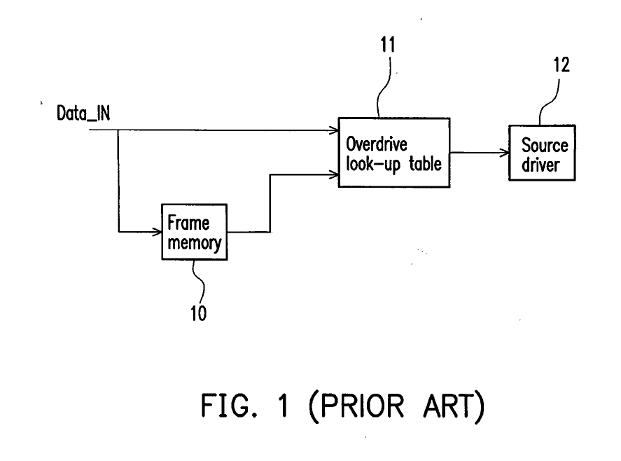

FIG. 2 is a circuit diagram of a first embodiment of the present invention.

FIG. 3 is a circuit diagram of a second embodiment of the present invention.

FIG. 4 is a circuit diagram of a third embodiment of the present invention.

FIG. 5 is a circuit diagram of a fourth embodiment of the present invention.

FIG. 6 is a circuit diagram of an asynchronous architecture of the first embodiment of the present invention.

FIG. 7 is a flow chart of a method of improving display quality of dynamic images on LCD according to the embodiment of the present invention.

FIG. 8 is a flow chart of the method of improving the display quality of dynamic images on LCD according to another embodiment of the present invention.

### DESCRIPTION OF EMBODIMENTS

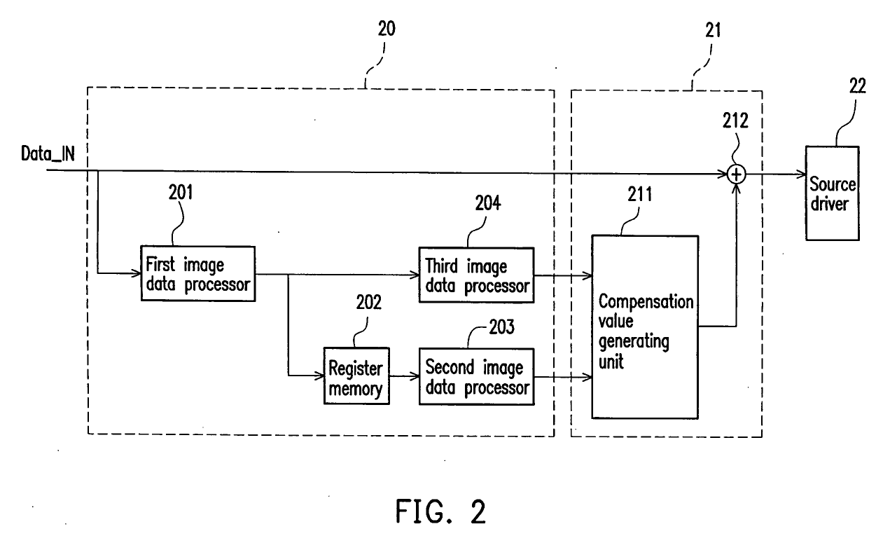

Referring to FIG. 2, it is a schematic circuit diagram of an apparatus for improving display quality of dynamic images on LCD according to an embodiment of the present invention. The circuit includes an image data processing unit 20 and an overdrive correcting unit 21. The overdrive correcting unit 21 is coupled to the image data processing unit 20. The image processing unit 20 receives image data (Data_IN as shown in the drawing), performs an image processing on the image data, and stores the image data of the previous frame after processing. The overdrive correcting unit 21 receives the image data of the previous frame sent from the image data processing unit and image data of a current frame, and generates overdrive image data corresponding to the image data of the previous frame and the image data of the current frame.

As shown in FIG. 2, in this embodiment, the image data processing unit 20 includes a first image data processor 201, a register memory 202, a second image data processor 203, and a third image data processor 204. The register memory 202 is coupled between the first image data processor 201 and the second image data processor 203. The third image data processor 204 is directly coupled to the first image data processor 201. The first image data processor 201 receives the image data Data_IN of the current frame, and performs image processing on the image data Data_IN. The register memory 202 stores the image data of the previous frame after the image processing performed by the first image data processor 201.

The second image data processor 203 receives the image data of the previous frame after being processed by the first image data processor 201 stored in the register memory 202, and performs a further image processing on the image data of the previous frame. The image processing is an inverse image processing relative to the first image data processor 201. For example, the image processing performed by the first image data processor 201 is compression, and the image processing performed by the second image data processor 203 is decompression correspondingly. The third image data processor 204 receives the image data of the current frame after being processed by the first image data processor 201, and performs the image processing on the image data. The image processing is an inverse image processing relative to the first image data processor 201. For example, the image processing performed by the first image data processor 201 is compression, and the image processing performed by the third image data processor 204 is decompression correspondingly.

As shown in FIG. 2, in this embodiment, the overdrive correcting unit 21 includes a compensation value generating unit 211 and an adder 212. The adder 212 is coupled to the compensation value generating unit 211 and the input image data Data_IN. The compensation value generating unit 211 receives the previous frame data output by the second image data processor 203 and the image data of the current frame output by the third processor 204, and generates a compensation value corresponding to the image data of the current frame. The adder 212 receives the image data Data_IN of the current frame before the image processing, and adds the value of the image data Data_IN with the obtained compensation value, so as to generate overdrive image data. A source driver 22 receives the overdrive image data sent from the overdrive correcting unit 21, and generates the corresponding analog driving signal, so as to drive a display panel.

In an embodiment, the compensation value generating unit 211 can include a look-up table for outputting the compensation values corresponding to the input image data. The look-up table only records a part of the compensation values corresponding to the input image data, and generates the compensation values corresponding to the input image data unrecorded in the look-up table by means of interpolation according to the recorded compensation values. Therefore, the memory capacity required by the look-up table in the compensation value generating unit 211 is smaller than the capacity required by the conventional overdrive correcting table, so on the required chip area, the area of the compensation value generating unit 211 provided by this embodiment can be smaller than the area of the overdrive correcting table of the conventional art.

The image processing method can be quantization, scaling, compression, decompression, transform, inverse transform, or combinations thereof. The image processing is performed on the image data of the previous frame, so number of bits of the image data is smaller than the number of bits of the image data before the image processing. Therefore, the capacity of the register memory 202 is smaller than the memory capacity required by storing a whole frame, so the chip area required by the register memory 202 is smaller than the area required by the memory chip required for storing a whole frame. In addition, the common transforming manners applicable to the image processing, can include transform on space, for example transform on YCrCb and YUV color space. In another embodiment, it can be transform on frequency domain, such as discrete cosine transform (DCT), two-dimension Fourier transform (2D FFT), or discrete wavelet transform (DWT).

The above embodiment is illustrated below in more detail through an example. It is assumed that in the record of the look-up table in the compensation value generating unit 211, the value of the image data of the previous frame is 0, the value of the image data of the current frame is 32, and the generated compensation value is 10. In addition, in the record of the look-up table in the compensation value generating unit 211, the value of the image data of the previous frame is 0, the value of the image data of the current frame is 48, and the generated compensation value is 20. According to the data, if the value of the image data of the previous frame is 0, and the value of the image data of the current frame is 41, the magnitude of the generated compensation value is illustrated in detail below.

If the image processing of the first image data processor 201 includes quantizing an image data of 8 bits to an image data of 6 bits, and performing a YUV (411) transform, the register memory 202 only needs ⅜ of the frame memory required by the conventional art. The second image data processor 203 receives the image data stored by the register memory 202, performs the YUV (411) inverse transform on the image data, and then performs a de-quantization processing on the image data to be the image data of 8 bits. The third image data processor 204 receives the data of the image processing performed on the image data of the current frame sent from the first image data processor 201, and performs the YUV (411) inverse transform on the image data. Then, the de-quantization processing is performed, and the image data of the current frame is obtained. The quantization, the YUV (411) transform, the YUV (411) inverse transform and the de-quantization are performed on the image data, so the value of the obtained image data is 40.

The compensation value generating unit 211 receives the image data of the previous frame and the image data of the current frame, and generates the compensation value by means of interpolation. Therefore, the compensation value is 10+(40−32)*(20−10)/(48−32)=15. Then, the adder 212 adds the value Data_IN of current image frame data before the image processing with the compensation value, so as to obtain the overdrive image data 41+15=56. The source driver 22 receives the image data after the overdrive compensation, and generates an analog driving signal to drive the LCD panel, thereby shortening response time of the LCD panel. For this example, the chip area required by the register memory 202 of the first embodiment is only ⅜ of the chip area of the memory in the conventional art, and the look-up table only needs a size of 17*17 instead of 256*256 in the conventional art. Therefore, the chip area of the apparatus for improving display quality of dynamic images on LCD provided by the present invention is smaller than that of the conventional art, thereby reducing the manufacture cost.

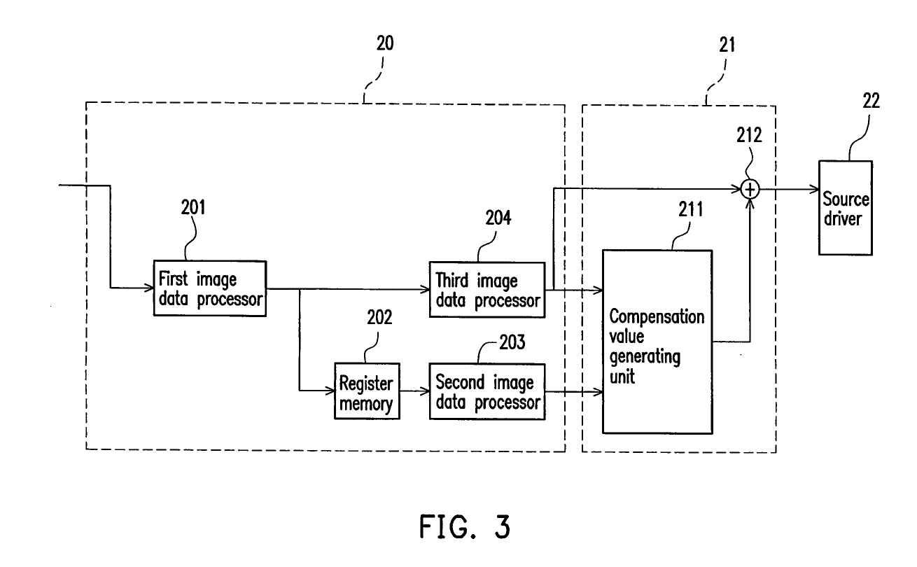

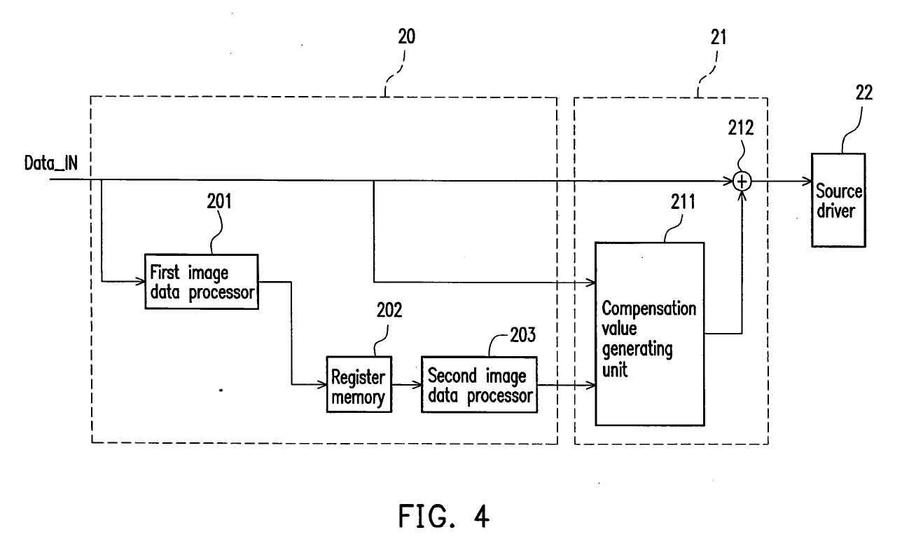

Next, referring to FIGS. 3 and 4, schematic circuit diagrams of other two different embodiments of the present invention are respectively shown. The difference between FIG. 3 and FIG. 2 is that the adder 212 adds the current frame data after the image processing with the compensation value, i.e., the received current frame data after the transform performed by the first image data processor 201, the image data after the inverse transform performed by the third image data processor 204, and the compensation value are added. For the above example, the final value of the overdrive image data is 40+15=55.

The difference between FIG. 4 and FIG. 2 is that the third image data processor 204 is omitted. Therefore, the compensation value generating unit 211 in FIG. 4 receives the current frame data Data_IN before the image processing and the image data of the previous frame after the image processing, i.e., the image data after the transform and the inverse transform, so as to generate the corresponding compensation value accordingly. Therefore, for the above example, the compensation value is 10+(41−32)*(20−10)/(48−32), being approximately 16 (result of decimal point round-off). Finally, the adder 212 adds the value of the current image data Data_IN and the compensation value, and generates the value of the overdrive image data of 41+16=57.

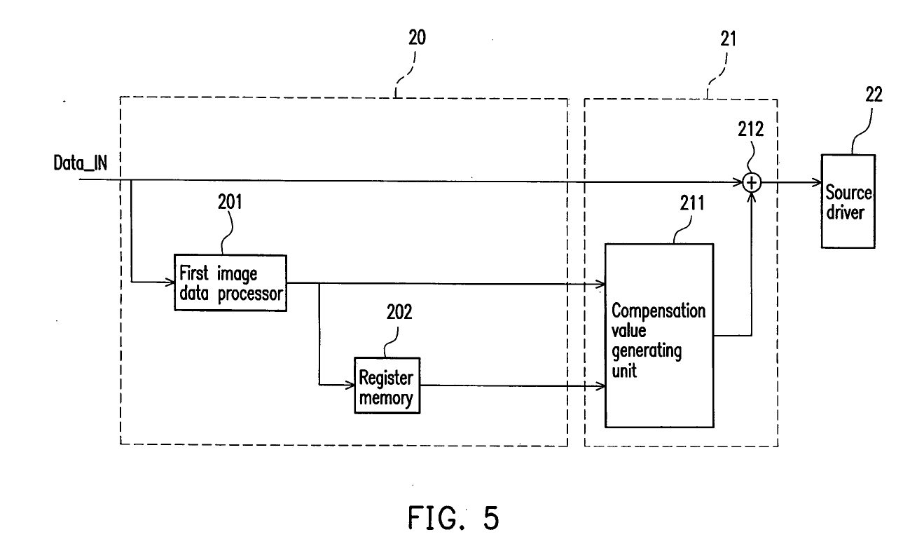

Referring to FIG. 5, a schematic circuit diagram of still another embodiment of the present invention is shown. As compared with FIG. 2, in this embodiment, the second image data processor 203 and the third image data processor 204 are omitted. The compensation value generating unit 211 receives the image data of the received current image data after being processed by the first image data processor 201, and the data of the image data of the previous frame after the image processing and being stored in the register memory 202, so as to generate a compensation value according to the two data. The adder 212 adds the value of the current image frame data Data_IN before the image processing and the compensation value, thereby generating the overdrive image data.

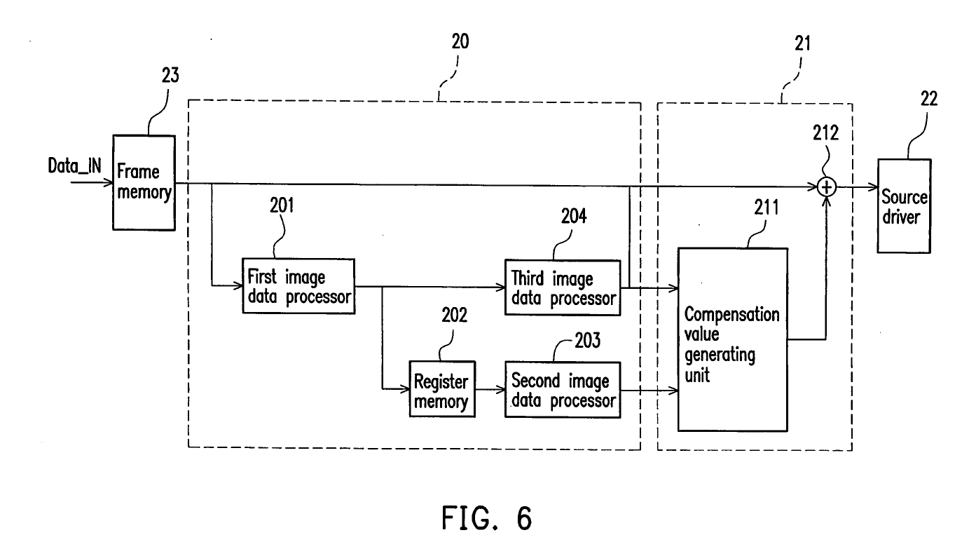

Referring to FIG. 6, a schematic circuit diagram of an asynchronous architecture of the embodiment of FIG. 2 of the present invention is shown. This embodiment further includes a frame memory 23. The frame memory 23 is coupled to the image processing unit 20. The frame memory 23 stores the image data of the current frame, but as write and read of the image data of the frame memory 23 are asynchronous, an apparatus for improving display quality of dynamic images on LCD having an asynchronous architecture is formed.

Referring to FIG. 6, the operation principle thereof is the same as that described above. Another example is given for illustration below to understand the apparatus for improving display quality of dynamic images on LCD. The frame memory 23 stores the image data of the current frame, but as write and read of the image data of the memory 23 are asynchronous, an apparatus for improving display quality of dynamic images on LCD having the asynchronous architecture is formed.

It is assumed that in the record of the look-up table in the compensation value generating unit 211, the value of the image data of the previous frame is 0, the value of the image data of the current frame is 80, and the generated compensation value is 20. In addition, in the record of the look-up table in the compensation value generating unit 211, the value of the image data of the previous frame is 0, the value of the image data of the current frame is 96, and the generated compensation value is 30. If the value of the image data of the previous frame is 0, and the value of the image data of the current frame is 85, the calculation of the compensation value is described as follows.

If the image processing of the first image data processor 201 includes quantizing an image data of 8 bits to an image data of 4 bits. In this manner, the register memory 202 only needs ½ of the frame memory required by the conventional art. The second image data processor 203 receives the image data of the register memory 202, and then performs the de-quantization processing. The third image data processor 204 receives the image data of the current frame after the image processing performed by the first image data processor 201, and then performs the de-quantization processing, so as to obtain the image data of the current frame having distortion characteristics and with the value of 80. The compensation value generating unit 211 receives the image data of the previous frame and the image data of the current frame, and generates a compensation value of 20. Next, the adder 212 adds the value of the current image frame data Data_IN before the image processing and the compensation value, so as to obtain the overdrive image data 85+20=105. The source driver 22 then receives the overdrive image data to generate an analog driving signal to drive the LCD panel, thereby shortening response time of the LCD panel.

For the above example, the memory capacity required by the register memory 202 of this embodiment is only half of that of the conventional art, that is, the occupied chip area is only ½ of the memory area of the conventional art, and the look-up table only needs a size of 17*17 instead of 256*256 in the conventional art. Therefore, the chip area of the apparatus for improving display quality of dynamic images on LCD provided by the present invention is smaller than that of the conventional art, thereby reducing the manufacture cost.

For the compensation value generating unit 211 in the above embodiment, the manner for calculating the compensation value can be implemented as the look-up table. In addition, a logic operation unit can be designed for a known overdrive function curve, thereby receiving the image data of the previous frame and the image data of the current frame and outputting the corresponding compensation value.

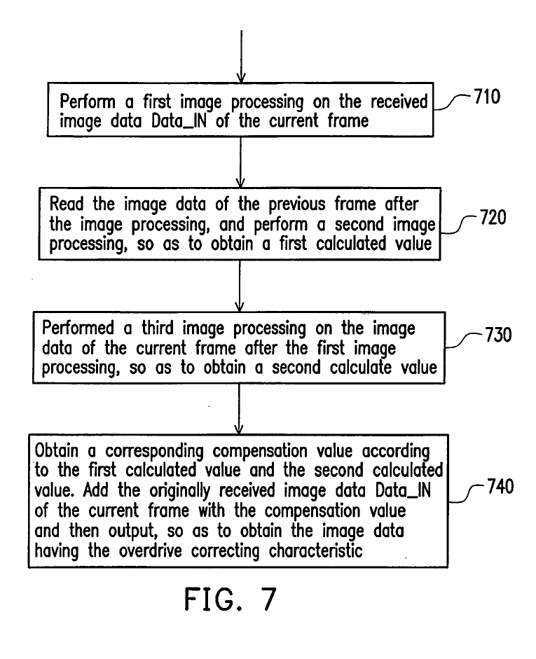

Referring to FIG. 7, a schematic flow chart of a method of improving display quality of dynamic images on LCD according to an embodiment of the present invention is shown. The method is suitable to perform an image data adjustment having overdrive correcting characteristic on the dynamic images of the display, so as to process successive images. However, for the convenience of illustration, the received image data Data_IN of the current frame and the data stored by the previous frame are illustrated below.

Firstly, in step 710, a first image processing is performed on the received image data Data_IN of the current frame. Then, in step 720, the image data of the previous frame after the image processing is read, and a second image processing is performed, so as to obtain a first calculated value. Next, in step 730, a third image processing is performed on the image data of the current frame after the first image processing, so as to obtain a second calculate value. The sequence of the second image processing and the third image processing can be exchanged or simultaneously performed, it is not limited to the described step sequence, and the second image processing and the third image processing are the inverse image processing of the first image processing. For example, if the first image processing is compression, the second image processing and the third image processing are decompression.

The image processing can be quantization, scaling, compression, decompression, transform, inverse transform or combinations thereof. The inverse image processing is the inverse processing of the above image processing. The common transforming manner being suitable for the image processing can be the transform on space domain or the transform on frequency domain. The transform on space can be, for example, transform on YCrCb and YUV color space. The transform on frequency domain can be, for example, DCT, 2D FFT, or DWT etc.

Next, in step 740, according to the first calculated value and the second calculated value, a corresponding compensation value is obtained by means of a look-up table or comparing a characteristic curve. The originally received image data Data_IN of the current frame is added with the compensation value and then output, so as to obtain the image data having the overdrive correcting characteristic, and to generate the analog driving signal accordingly to drive the LCD panel, thereby shortening the response time of the LCD panel.

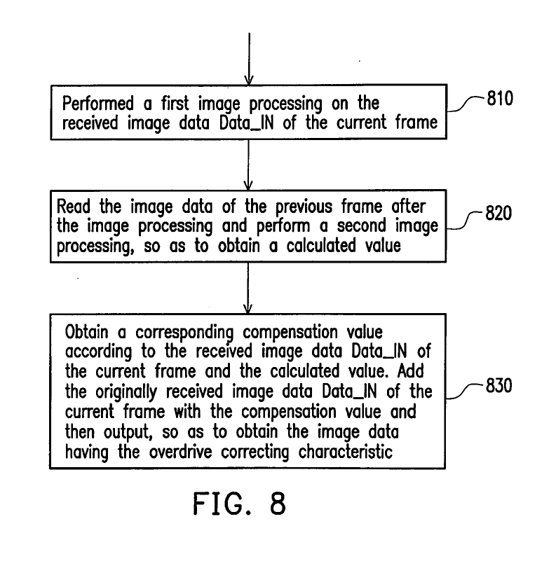

Referring to FIG. 8, a schematic flow chart of the method of improving display quality of dynamic images on LCD according to another embodiment of the present invention is shown. Firstly, in step 810, a first image processing is performed on the received image data Data_IN of the current frame. Then, in step 820, the image data of the previous frame after the image processing is read and a second image processing is performed, so as to obtain a calculated value. The second image processing manner is the inverse image processing of the first image processing. For example, if the first image processing manner is compression, the second image processing manner is decompression. The image processing can be quantization, scaling, compression, decompression, transform, inverse transform or combinations thereof. The inverse image processing is the inverse processing of the above image processing.

Next, in step 830, according to the received image data Data_IN of the current frame and the calculated value, a corresponding compensation value is obtained by means of a look-up table or comparing a characteristic curve. The originally received image data Data_IN of the current frame is added with the compensation value and then output, so as to obtain the image data having the overdrive correcting characteristic, and to generate the analog driving signal accordingly to drive the LCD panel, thereby shortening the response time of the LCD panel.

To sum up, in the apparatus for improving display quality of dynamic images on LCD and the method thereof provided by the present invention, an image processing unit 20 is adopted. Firstly, an image processing is performed on the image data, and the image data of the previous frame after the processing performed by the image processing unit 20 is stored and compared. Under the scope of the allowable distortion, few data is used to obtain the calculation of the compensation value. Number of bits of the image data of the previous frame after the image processing is smaller than the number of bits of the image data of a whole frame, so it is unnecessary to use a frame memory to wholly store the image data of a whole frame. Therefore, the memory capacity required by the apparatus for improving display quality of dynamic images on LCD is reduced, that is to say, the chip area required by the memory is saved, thereby reducing the manufacture cost. It can be known from a part of the embodiments that the apparatus for improving display quality of dynamic images on LCD and the method thereof can flexibly adjust the memory capacity and the image processing method.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An apparatus for improving display quality of dynamic images on a display, comprising:
an image data processing unit, for receiving a successive image data, performing an image processing operation on the image data, and storing image data of a previous frame after processing, wherein the image data processing unit comprises:
a first image data processor, for performing the image processing operation on input image data; and
a memory, coupled to the first image data processor, for recording the image data of the previous frame after the image processing operation performed by the first image data processor; and
an overdrive correcting unit, coupled to the image data processing unit, for receiving the image data of the previous frame sent from the image data processing unit and image data of a current frame, and generating overdrive image data corresponding to the image data according to the image data of the previous frame and the image data of the current frame.

2. The apparatus for improving display quality of dynamic images on a display as claimed in claim 1, wherein the image data processing unit further comprises:
a second image data processor, coupled between the memory and the overdrive correcting unit, for performing an inverse image processing operation on the image data of the previous frame relative to the first image data processor; and
a third image data processor, coupled between the first image data processor and the overdrive correcting unit, for performing the inverse image processing operation on the image data of the current frame relative to the first image data processor.

3. The apparatus for improving display quality of dynamic images on a display as claimed in claim 1, wherein the image data processing unit further comprises:
a second image data processor, coupled between the memory and the overdrive correcting unit, for performing the inverse image processing operation on the image data of the previous frame relative to the first image data processor.

4. The apparatus for improving display quality of dynamic images on a display as claimed in claim 1, wherein an area of the memory is smaller than an area of a memory required to store a whole frame.

5. The apparatus for improving display quality of dynamic images on a display as claimed in claim 1, further comprising:
a frame memory, coupled to the image data processing unit, for storing the image data of the current frame.

6. The apparatus for improving display quality of dynamic images on a display as claimed in claim 1, wherein the method of image processing operation comprises quantization, scaling, compression, decompression, transform, inverse transform or combinations thereof.

7. The apparatus for improving display quality of dynamic images on a display as claimed in claim 1, wherein the overdrive correcting unit comprises:
a compensation value generating unit, for receiving the image data of the previous frame output by the image processing unit and the image data of the current frame before or after the image processing operation, and generating corresponding compensation values; and
an adder, coupled to the compensation value generating unit, for performing addition operation or subtraction operation on the value of the image data of the current frame before or after the image processing operation with the compensation value, so as to generate the overdrive image data.

8. The apparatus for improving display quality of dynamic images on a display as claimed in claim 7, wherein the compensation value generating unit comprises:
a look-up table, for outputting the compensation values corresponding to the input image data.

9. The apparatus for improving display quality of dynamic images on a display as claimed in claim 8, wherein the look-up table only records a part of the compensation values corresponding to the input image data, and generates unrecorded compensation values corresponding to the input image data by means of interpolation according to the recorded compensation values.

10. The apparatus for improving display quality of dynamic images on a display as claimed in claim 9, wherein the look-up table is recorded in a look-up table memory.

11. The apparatus for improving display quality of dynamic images on a display as claimed in claim 10, wherein the look-up table memory is a non-volatile memory.

12. The apparatus for improving display quality of dynamic images on a display as claimed in claim 7, wherein the compensation value generating unit comprises:
a logic operation unit, for generating compensation values corresponding to the input image data.

13. A method of improving display quality of dynamic images on a display, comprising:
receiving a successive image data, and performing a first image processing operation on the successive image data;
performing a second image processing operation on the data of the previous frame of a current frame in the successive image data after the first image processing operation, so as to obtain a calculated value;
obtaining a compensation value by means of looking-up or comparing a characteristic curve, according to the image data of the current frame before or after the first image processing operation and the calculated value; and
outputting the image data of the current frame after adding the compensation value, so as to serve as the image data having an overdrive correcting characteristic for being displayed by the dynamic images on the display.

14. The method of improving display quality of dynamic images on a display as claimed in claim 13, wherein the second image processing operation is the inverse image processing of the first image processing operation.

15. The method of improving display quality of dynamic images on a display as claimed in claim 13, wherein the first image processing operation is a compression processing operation, and the second image processing operation is a decompression processing operation.

16. The method of improving display quality of dynamic images on a display as claimed in claim 13, wherein the first image processing operation is a transform processing operation, and the second image processing operation is an inverse transform processing operation.

17. The method of improving display quality of dynamic images on a display as claimed in claim 16, wherein the transform processing is a transform on space.

18. The method of improving display quality of dynamic images on a display as claimed in claim 17, wherein the transform on space is a transform on YUV color space.

19. The method of improving display quality of dynamic images on a display as claimed in claim 16, wherein the transform processing is a transform on frequency domain.

20. The method of improving display quality of dynamic images on a display as claimed in claim 19, wherein the transform on frequency domain is one from among discrete cosine transform (DCT), two-dimensional Fourier transform (2D FFT), and discrete wavelet transform (DWT).

21. The method of improving display quality of dynamic images on a display as claimed in claim 13, wherein the looking-up of the image data of the current frame after the first image processing operation and the calculated value is querying by using a look-up table.

22. A method of improving display quality of dynamic images on a display, comprising:
receiving a successive image data, and performing a first image processing operation on the successive image data;
performing a second image processing operation on the data of the previous frame of a current frame in the successive image data after the first image processing operation, so as to obtain a first calculated value;
performing a third image processing operation on the image data of the current frame after the first image processing operation, so as to obtain a second calculated value;
obtaining a compensation value by means of looking-up or comparing a characteristic curve, according to the first calculated value and the second calculated value; and
outputting the image data of the current frame before or after the first image processing operation after adding the compensation value, so as to serve as the image data having overdrive correcting characteristic for being displayed by the dynamic images on the display.

23. The method of improving display quality of dynamic images on a display as claimed in claim 22, wherein the second image processing operation and the third image processing are inverse image processing of the first image processing.

24. The method of improving display quality of dynamic images on a display as claimed in claim 22, wherein the first image processing operation is a compression processing operation, and the second image processing operation and the third image processing operation are decompression processing operation.

25. The method of improving display quality of dynamic images on a display as claimed in claim 22, wherein the first image processing operation is a transform processing operation, and the second image processing operation and the third image processing operation are inverse transform processing operation.

26. The method of improving display quality of dynamic images on a display as claimed in claim 25, wherein the transform processing operation is a transform on space.

27. The method of improving display quality of dynamic images on a display as claimed in claim 26, wherein the transform on space is a transform on YUV color space.

28. The method of improving display quality of dynamic images on a display as claimed in claim 25, wherein the transform processing operation is a transform on frequency domain.

29. The method of improving display quality of dynamic images on a display as claimed in claim 28, wherein the transform on frequency domain is one from among DCT, 2D FFT, and DWT.

30. The method of improving display quality of dynamic images on a display as claimed in claim 22, wherein the looking-up of the image data of the current frame after the first image processing operation and the first calculated value is querying by using a look-up table.
